(19) United States
(12) Patent Application Publication
(10) Pub. No.: US 2006/0175782 A1
(43) Pub. Date: Aug. 10, 2006

(54) Golf bag

(75) Inventors: Ki-Dal Shin, Pusan (KR); Chang-Won Lee, Pusan (KR)

Correspondence Address: JORDAN AND HAMBURG LLP, 122 EAST 42ND STREET, SUITE 4000, NEW YORK, NY, 10168, US

(73) Assignees: Doosung Industry Co., Ltd., Kimhae city (KR); Ki-Dal SHIN, Pusan (KR)

(21) Appl. No.: 11/053,166

(22) Filed: Feb. 7, 2005

(51) Int. Cl. B62B 1/00

(52) U.S. Cl. 280/47.26

(57) ABSTRACT

A golf bag is provided which includes a lift pipe fitted into a guide pipe and which moves vertically along the guide pipe. A top end of the lift pipe protrudes upwardly from the golf bag body. Vertical movement of the lift pipe is lockable and unlockable by a locking device an unlocking device. A pair of wheels is provided that is rotationally mounted on front and lower side corners of a main frame. A connecting structure is provided such that vertical movement of the lift pipe causes the wheels to move horizontally so that the intervals between the wheels increase.

### BACK GROUND OF THE INVENTION

1. Field of the Invention

The present invention relates to a golf bag, in particular, to a golf bag which can separately and classifiably receive a set of golf clubs including woods, irons and putters in separate rooms respectively in the manner of upside-down of the iron heads such that the clubs received therein can be prevented from being collided or contacted with each other and from being damaged by such a collision or contact, and center of gravity in the golf bag can be more lowered, also to a golf bag which has a wheel unit, rotationally mounted on front and down side corners of the base frame such that the wheels can be moved horizontally and be retracted interiorly and extended exteriorly from the bag, so as to more stably move the bag by increasing or decreasing the interval of the both wheels extended more widely.

2. Description of the prior Art

Generally, a set of golf clubs consist of about three woods, about nine to ten irons, and a putter or more, all of which are received in the golf bag in manner that top ends, or heads of the clubs are protruded from the golf bag because lengths of the clubs are typically longer than those of the golf bag body.

And a cap detachably attached to higher portion of the golf bag covers the exposed heads of the clubs to prevent the clubs from being escaped from the golf bag and from being damaged due to collision or contacting of the exposed club heads.

Such a golf bag of prior art includes typically a base frame, a top frame, a main frame assembled between the base frame and the top frame, an outer cover having a plurality of pockets for receiving some small pieces or articles, and a cap which has a length to the extent that it can cover the protruded heads of the clubs. The outer covers is cover or combined with all or some part of the frames. And the cap is detachably attached to the top frame, for example by a hook button.

And in the prior golf bag, a carrying handle for easily carrying the golf bag is disposed on the higher portion of the backside in the main frame. Also, the top frame has three rooms formed by two cross partition walls, whereas the main frame disposed just below the top frame is not partitioned by the partition walls so as to form single big room. And in the direction from the backside to front side of the golf bag, the woods, the irons and the putters are, in sequence, received in the rooms of the top frame such that the heads of the clubs are exposed from the upper portion of the golf bag.

In recent years, the golf bag tends to have a pulling handle protruded and exposed from the upper portion of the front side on the main frame to easily pull the golf bag on the ground in aid of one or two wheels rotationally mounted on the front side and lower portion in the base frame. And also a plurality of legs being downwardly protruded from the base frame and spaced with each other adjacent to both side or backside of the base frame such that the wheels may not be touched with the ground when the golf bag stops and stands up without moving.

The prior golf bag receives the clubs in the three partitioned-rooms of the top frame in the manner that the heads of the clubs are exposed from the upper portion of the top frame and grips of the clubs are inserted into the main frame or the base frame via the top frame. And since the received clubs of, for example, normally 13 to 14 are in close together in relatively narrower spaces, they can be easily collided or rubbed with each other by contacting between adjacent heads or between heads of the shorter clubs and shaft of the longer clubs, especially when moving the golf bag. As a result, the clubs received in the golf bag tend to be easily damaged by the collision or the friction, which leads to the shorter lifetime of the clubs as well as some noise. And since the main frame of the golf bag consists of a single room having hollow therein, the shafts or the heads of the clubs received therein tend to be easily biased to one side. This, also, makes it difficult to easily insert into or take out the clubs in the golf bag.

And since the heads of the golf clubs made from the heavy metal are exposed from the upper portion of the golf bag on which, as a result, the center of gravity is mainly concentrated, the stability of the golf bags is deteriorated such that the golf bags in stand-up status tend to easily fall backward or forward by some blown winds or some small force urged thereto to often damage the clubs received therein. And the higher center of gravity in the golf bags causes the bags to be tilted backward or forward by biased force thereof when carrying them off or on the ground, which also, makes it difficult to handle the golf bag.

Recently, in order to solve the tiling tendency of the golf bag based on the higher center of gravity thereof, a golf bag of which top frame has a plurality of openings for fitting the irons therein has been disclosed. This structure can prevent the heads of the irons received therein from being biased to one side of the bag. However, since the interior of the main frame in the golf bag is still made as a single hollow room and the club heads are still protruded from the upper portions of the top frame, the club heads in the bag can be easily collided or rubbed with each other and the higher center of gravity in the bags still leads to the problems of the prior art mentioned above.

Meanwhile, in a golf bag of the prior art, single wheel is mounted on the lower end and middle portion of front side in the base frame thereof. Therefore, when moving the golf bag with the one wheel on the ground from place to place under golf rounding, the moving bag may be easily and frequently biased to one side to be in unbalance, at the worst, to be fallen down such that the clubs can be very easily collided or rubbed with each other to be damaged or may be got entangled in a state to uneasily take in or out the clubs in the bag. Therefore the man who pulls and carries the golf bag with one wheel should handle it with his heart's blood.

In order to solve the problem in the golf bag of the one wheel type, another golf bag having two wheels spaced and mounted on the front and lower end of the base frame has been disclosed. This can improve the stability or balance of the golf bag more than that of the one wheel type. However, the golf bag of two wheel type has almost the same problems as the golf bag of one wheel type has because the width of the base frame on which the two wheel are mounted relatively narrower so that the interval between two wheels is not long enough to provide the desired balance for the golf bag.

### SUMMARY OF THE INVENTION

Accordingly, in order to solve the prior problems mentioned above, the first purpose of present invention provides a golf bag wherein a longitudinal partition wall and a plurality of cross partition walls crossing the longitudinal partition wall are formed in the main frame and extended downwardly between a lower end of the top frame and an upper end of the base frame, such that the cross partition walls and the longitudinal partition wall forms together separate rooms of a lattice type having a plurality of iron receivers in the middle thereof, at least one wood receiver and at least one putter receiver in the both side of the iron receivers in the front-to-back direction of the bag, and wherein heads of the irons are inserted into the base frame located on the lower portion of the golf bag body in the manner of upside-down of the irons so that the center of gravity in the golf bag become more lower than that of prior one.

And the second purpose of present invention provide a golf bag for receiving and carrying a plurality of golf clubs therein, a pair of wheels, rotationally mounted on front and down side corners of the base frame such that the intervals between the two wheels can be increased or decreased; whereby the golf bag can be prevented from being biased to one side or fallen backward or forward, and can be more easily and stably moved in aid of wider-interval wheels.

In accordance with present invention, as a premise structure, the golf bag body includes a base frame on the lower portions thereof, a top frame on the top portions thereof, a main frame located between and combined integrally with the base frame and the top frame, an outer cover covering wholly and being combined with the golf bag body, and a cap detachably combined with the top frame, the cap having variable heights corresponding to those of heads of the golf clubs which are being received in the bag.

And as the first preferable characteristic of the present invention, the golf bag includes a plurality of cross partition walls and a longitudinal partition wall be crossed by said the cross partition walls in the main frame such that the cross partition walls and the longitudinal partition wall forms together separate rooms of a lattice type having a plurality of iron receivers in the middle thereof, at least one wood receiver and at least one putter receiver in the both side of the iron receivers in the front-to-back direction of the bag, and wherein heads of the irons are inserted into the base frame located on the lower portion of the golf bag body in the manner of upside-down of the irons so that the center of gravity in the golf bag become more lower and the club heads can be prevented from being collided or rubbed with each other.

As the second preferable characteristic of present invention, the golf bag includes a guide pipe longitudinally and fixedly mounted on the middle portion of the front face of the main frame for guiding a lift pipe which is movably fitted into the guide pipe, a locking means disposed within the guide pipe for stopping the movement of the lift pipe, an unlocking means disposed within the guide pipe for releasing the unmovable state of the lift pipe, a pair of wheels, rotationally mounted on front and down side corners of the base frame, each of the wheels connected with the corresponding shaft on one end thereof, a connecting means by which vertical movement of the lift pipe can causes the wheels to come in or out from the corners of the base frame, whereby the golf bag can be prevented from being biased to one side or fallen backward or forward, and can be easily moved in aid of wider-interval wheels.

Still preferably, in the golf bag of present invention, the iron receivers increase in their sizes along both middle-to-forward and middle-to-backward directions of the bag, such that the iron receivers can be adapted to shapes and sizes of iron heads determined based on iron lofts.

Still preferably, in the golf bag of present invention, the locking means includes a casing fixedly fitted on inner portion of and in predetermined height of the lift pipe, the casing having an opening on upper end and a closure on lower end; an engaging bar disposed within the case, the engaging bar having a through hole having a downward-incline plane on an interior side wall thereof to downwardly and gradually reduce opening size of the through hole; higher and lower engaging holes passing through lower and higher portions of one side wall of the guide; a path hole passing through adjacent one-side walls of both the lift pipe and the casing which are adjacent to said one side wall of the guide; and a spring attached between an end of the engaging bar piece and other side wall of the casing to normally urge the engaging bar to said one side wall of the casing such that the engaging bar can be engaged with one of the lower and higher engaging holes.

Still preferably, in the golf bag of present invention the unlocking means includes: a slope piece vertically and movably fitted on the casing, the slope piece having an incline plane matching with the incline plane of the through hole, whereby when the slope piece is inserted into the through hole, the engaging bar is moved against the force of the spring by the action of the incline planes of both the through hole and the slope piece so as to release the locking status between the guide pipe and the lift pipe; a secession-prevention means preventing said slope piece from being escaped from the casing; a lift handle fixedly mounted on the top end of the lift pipe, the lift handle having a pressing button on the middle thereof, and button springs pressing upwardly the pressing button; a pressing rod connected between a lower end of the press button and a top end of the slope piece to transmit pressing force of the press button to the slope piece.

Still preferably, in the golf bag of present invention, the secession-prevention means includes a prolonged slot vertically extended on the slope piece, and a stopper formed on the casing, wherein a protruded end of the stopper is idly inserted into the prolonged slot such that the slope piece can be moved between an upper limit for escaping the engaging bar from the one of the lower and higher engaging holes and a lower limit for inserting the engaging bar into the one of the lower and higher engaging holes.

Still preferably, in the golf bag of present invention, the connecting means includes: a pair of links which have one ends pivotally and commonly connected with said junction means of the lift pipe by a pin, and other ends of the links separately and pivotally connected with other end of each shaft by pins respectively; and a snap spring, a middle portion of which is pivotally connected with the junction means of the lift pipe, and both ends of which is pivotally and separately connected with about middle portions of the links.

### BRIEF DESCRIPTION OF THE DRAWINGS

Other objects and aspects of the present invention will become apparent from the following description of embodiments with reference to the accompanying drawing in which:

FIG. 1 is a perspective view of a golf bag according to an embodiment of present invention.

FIG. 2 is a partially exploded perspective view of a main frame, a base frame and a top frame in the golf bag according to an embodiment of present invention.

FIG. 3 is a longitudinal cross sectional view of a golf bag body according to an embodiment of present invention.

FIG. 4 is a perspective view of a wheel unit in the golf bag according to an embodiment of present invention.

FIG. 5 is a partially exploded perspective view of a connecting means disposed on a lower portion of the wheel unit according to present invention.

FIG. 6 is a cross sectional view of a locking means and an unlocking means disposed on an upper and inner portion of the wheel unit according to present invention.

FIG. 7 is a cross sectional view showing an operating status of an engaging bar.

FIG. 8 is a cross sectional view showing an extracted and extended status of wheels which are linked with action of a lift pipe.

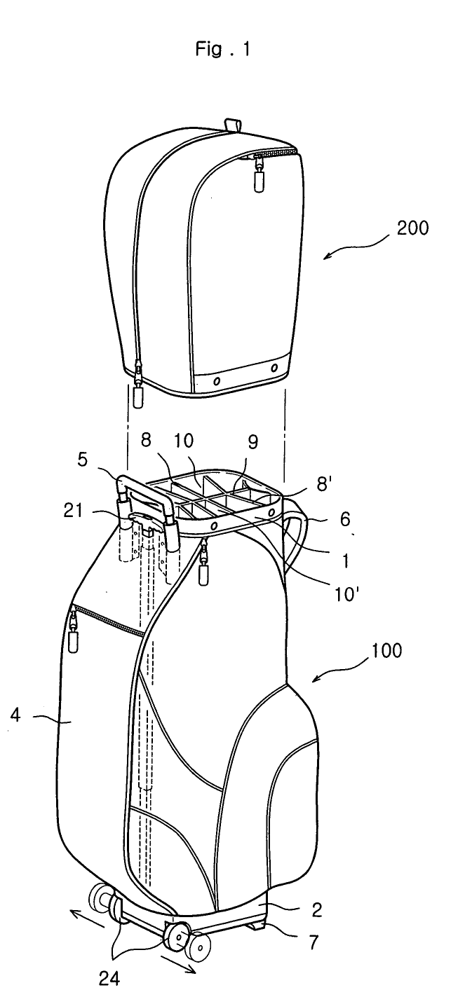

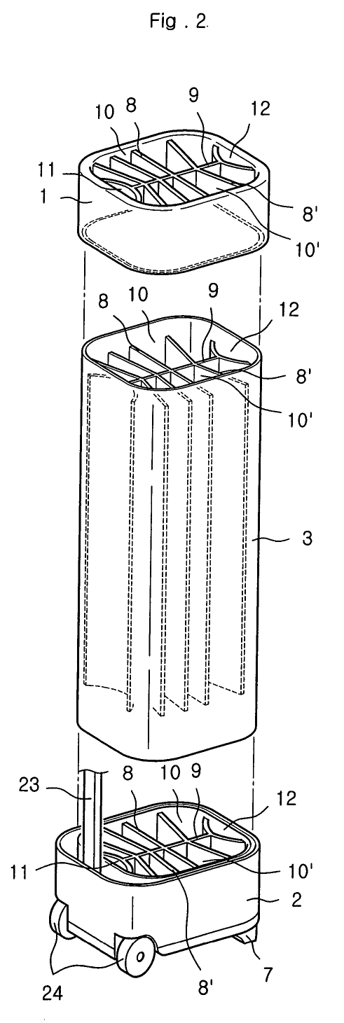

### DETAILED DESCRIPTION OF THE PREFERRED EMBODIMENTS

The golf bag of present invention comprises a golf bag body 100 including a main frame 3, a base frame 2 assembled on the bottom of the main frame 3, a top frame 1 assembled on the higher portion of the main frame 3, an outer cover 4 covering and being combined integrally with all the frames 1, 2 and 3. And a pulling handle 5 for pulling the golf bag on the ground is attached to a front side and relatively higher portion of the golf bag body. Similarly, a carrying handle 6 for carrying the golf bag on or off the ground is attached to a backside and relatively higher portion of the golf bag body. And a plurality of legs are spaced with each other and downwardly protruded from the base frame 2. And the golf bag further comprises a cap 200 detachably attached to the top frame 1. The cap 200 has a height corresponding to those of the club heads(H) received in the golf bag.

The main frame 3 extended vertically between the lower end of the top frame 1 and the upper end of the base frame 2. The main frame 3 includes a longitudinal partition wall 9 extended in the direction from the front side to the backside and at the same time along the center line of the main frame width, and a plurality of cross partition walls 8 and 8′ crossing the longitudinal partition wall 9 in the form of a lattice, which forms a plurality of separated rooms including iron receivers 10 and 10′, wood receivers 11 and putter receivers 12. And the irons can be received in the iron receivers 10 and 10′ in the manner of upside-down so that the iron heads H can be rested on interior of the base frame 2.

The cross partition walls 8 and 8′ and the longitudinal partition wall 9 for forming together the receivers extend vertically in the golf bag body 100 which extends from the top frame 1 to the base frame 2. And the iron receivers 10 and 10′ have various sizes corresponding to those of iron heads which are determined based on the iron lofts, such that widths of the iron receivers 10 and 10′ increase gradually in the direction from the center to outer sides, and can be adapted to shapes of the iron heads H.

The top frame 1, the base frame 2 and the main frame 3 are separately manufactured and then later are assembled integrally together with each other to form the golf bag body 100. The top frame 1 has openings both on upper end and lower end thereof and the base frame 2 has an opening on upper end thereof and a closure on lower end thereof. The cross partition walls 8 and 8′ and the longitudinal partition wall 9 are also formed on both the top frame 1 and the base frame 2. And the cross partition walls 8, 8′ and the longitudinal partition wall 9 of all the frames are covered with continuous texture or cushion material for protecting the iron or the iron heads which would be frequently taken in or out in the golf bag. Also, the continuous texture or cushion can assist coupling of the frames by covering continuously all the frame together.

In accordance with present invention, the golf bag includes a wheel unit 20. The wheel unit 20 includes a guide pipe vertically extended and fixedly mounted on the middle portion of the front side of the main frame 3 for guiding a lift pipe 23. Also, the wheel unit 20 includes the lift pipe 23 which is fitted into the guide pipe 22 and vertically movable along the guide pipe 22. The lift pipe 23 has a lift handle 21 on the top end thereof and a junction means on the lower portion thereof. A higher end of the lift pipe 23 is protruded upwardly and exteriorly from higher portion of the golf bag body 100. And a locking means is disposed within the guide pipe 22 for stopping the movement of the lift pipe 23. And also, an unlocking means is disposed within the guide pipe 22 for releasing the unmovable state of the lift pipe 23. The wheel unit 20 also includes a pair of wheels which are rotationally mounted on front side and lower corners of the base frame 2, each of the wheels being connected with shafts 25 on one end thereof, and a connecting means which is pivotally mounted between the junction means of the lift pipe 23 and the wheel shafts 25 such that vertical movement of the lift pipe 23 can cause both the connecting means and the wheels to move horizontally and also cause the wheels 24 to increase or decrease the intervals between the two wheel in the left-to-right direction or horizontal direction of the golf bag.

When the golf bag stays or stands up without moving, the wheels 24 is slightly lifted from the ground and is not touched on the ground because the legs 7 are formed on some portions of the base frame 2 opposite to the wheels and the legs 7 have lengths longer than diameters of the wheels such that the legs can support the golf bag in standing-up status on the ground without the wheels. Therefore, the golf bag in standing-up status does not slide or fall down easily with rolling of the wheels 24. Of course, there are no legs 7 formed around on the portions on or adjacent to which the wheels are mounted.

The locking means includes a casing 31 which is fixedly fitted in inner portion of and in predetermined height of the lift pipe 23, and has an opening on upper end and a closure on lower end. Also, the locking means includes an engaging bar 35, a higher engaging hole 36 and a lower engaging hole 37, a path hole and a spring 34.

The engaging bar 35 is disposed within the casing 31, and has a through hole 32 having a downward-incline plane on an interior side wall thereof to downwardly and gradually reduce opening size of the through hole 32.

The higher and lower engaging holes 36 and 37 pass through lower and higher portions of one side wall of the guide pipe 22. And the path hole passes through adjacent one-side walls of both the lift pipe 23 and the casing 31 which are adjacent to said one side wall of the guide pipe 22.

And a spring 34 is attached between an end of the engaging bar 35 and other side wall of the casing to normally urge the engaging bar to said one side wall of the casing such that the engaging bar 35 can be engaged with one of the higher and lower engaging holes 36 and 37 (which is “locking state”) so as to stop the vertical movement of the lift pipe 23.

The unlocking means includes a slope piece 41, a secession prevention means, a lift handle 21, and a pressing rod 44. The slope piece 41 is vertically and movably fitted in the casing 31. And the slope piece has an incline plane matching with an incline plane of the through hole 32, whereby when the slope piece 41 is inserted into the through hole 32, the engaging bar 35 is moved against the force of the spring 34 by the action of the incline planes of both the through hole 32 and the slope piece 41 so as to release the locking state between the guide pipe 22 and the lift pipe 23.

The secession-prevention means prevents said slope piece 41 from being escaped from the casing 31. And the lift handle 21 is fixedly mounted on the top end of the lift pipe 23. The lift handle 21 has a pressing button 43 on the middle and upper end portion thereof, and button springs 42 for pressing upwardly the pressing button 43. And the pressing rod 44 is connected between a lower end of the press button 43 and a top end of the slope piece 41 to transmit pressing force of the press button to the slope piece 41.

When operator press downwardly the pressing button 43, the pressing force of the pressing button 43 is transmitted to the slope piece 41 via the pressing rod 44. As a result the slope come down and come into the through hole 32 which in turn urges the engaging bar 35 against the force of the spring 34 such that end portion of the engaging bar 35 escapes from the one of the engaging holes 36 and 37, which is “unlocking state” of the lift pipe 23. Then, the lift pipe 23 can be vertically and freely moved along the guide pipe 22.

Preferably, the pressing rod 44 has a lower end of which bottom surface area is relatively larger than other portion of the rod 44. And the lower end of the pressing rod 44 is contacted with upper surface of the slope piece 41 so that the pressed force of the pressing button can be effectively transmitted to the slope piece 41.

The succession-prevention means includes a prolonged slot 51 vertically extended on the slope piece 41, and a stopper 52 formed on the casing 31. An protruded end of the stopper 52 is idly inserted into the prolonged slot 51 such that the slope piece 41 can be moved between an upper limit for escaping the engaging bar 35 from the one of the higher and lower engaging holes 36 and 37 and a lower limit for effectively inserting the engaging bar 35 into the one of the higher and lower engaging holes 36 and 37. That is, the prolonged slot 51 has a length enough to allow the slope piece 41 to move between the upper limit and the lower limit.

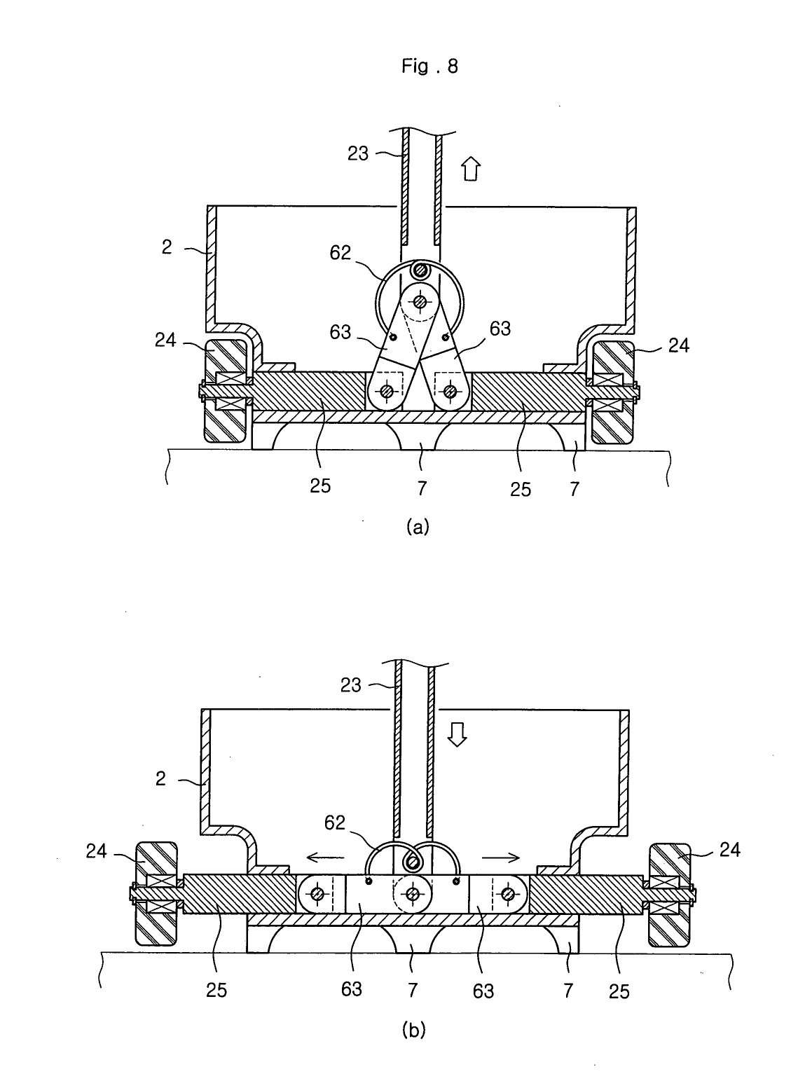

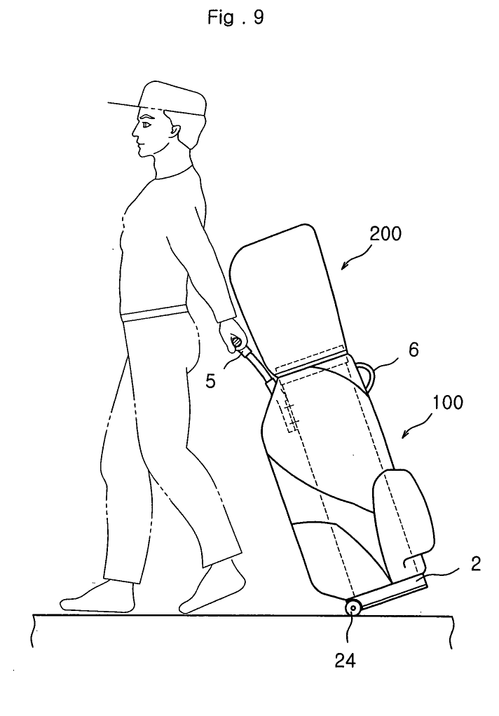

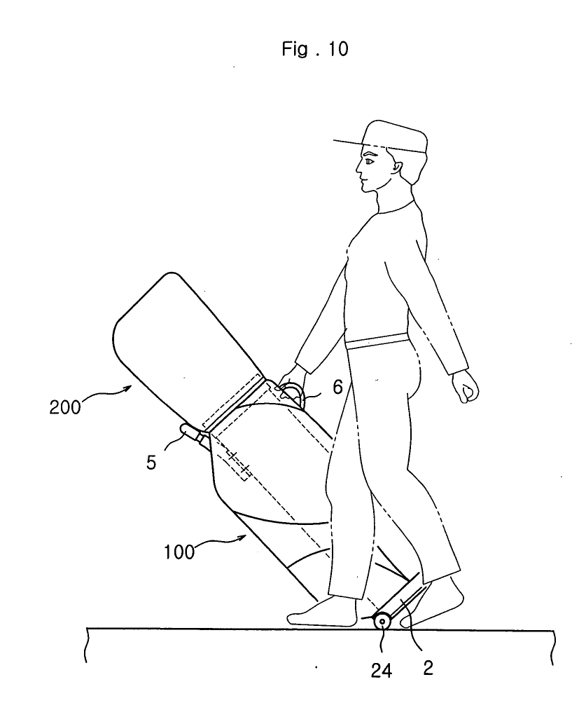

The connecting means includes a pair of links 63 which have ends pivotally and commonly connected with said junction means of the lift pipe 23 by a pin 61. And other ends of the links are pivotally connected with the other ends of shaft 25 by pins 61 respectively. And the connecting means also includes a snap spring 62, a middle portion of which is pivotally connected with the junction means of the lift pipe 23, and both ends of which is pivotally connected with about middle portions of the links 63 respectively as shown in FIGS. 8 and 9.

When the lift pipe 23 moves upwardly or downwardly, the pair of links 63 is changed from vertical standing status to horizontal status, which as a result, causes the wheels to come in or out from the corners of the base frame 2 by decreasing or increasing the intervals between the two wheels as shown in FIGS. 8 and 9. Therefore the intervals between the two wheels are determined based on the lengths of the links 63. Also, the interval between the higher engaging hole 36 and the lower engaging hole 37 are determined based on difference between heights of horizontal status and standing status in the links 63.

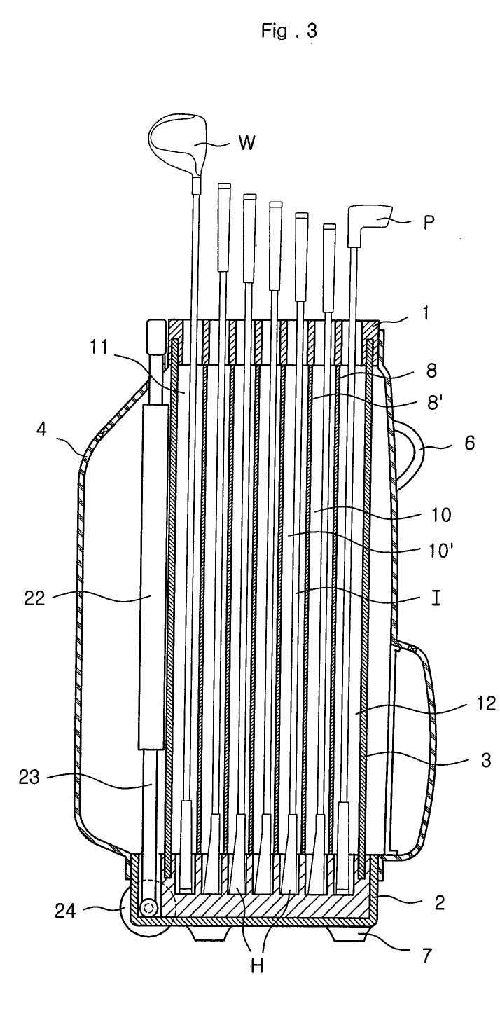

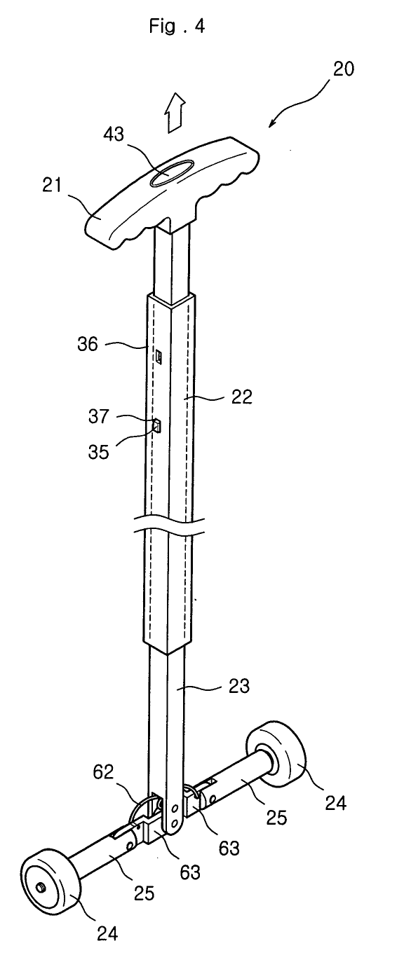

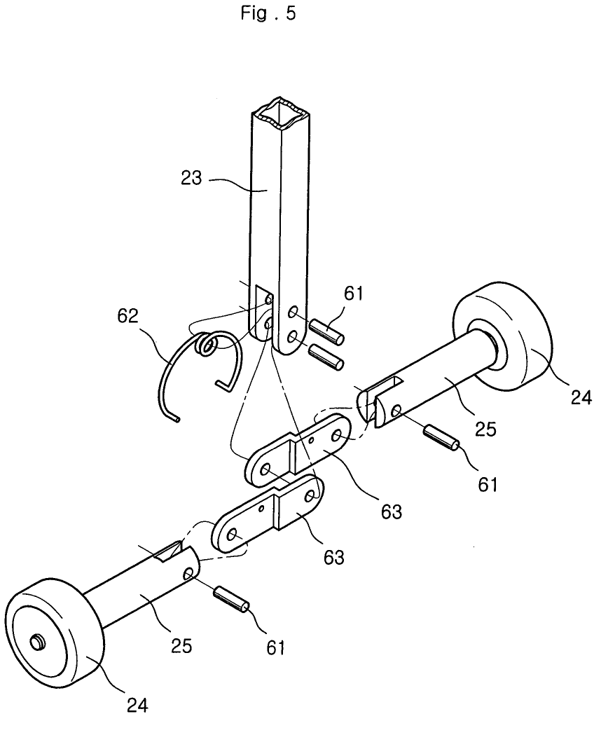

When the lift pipe 23 elevates up to the higher limit, the shape of the pair of the links 63 changes into a “reversed V” with lower ends of the links spaced slightly with each other. Such a structure of the links facilitates the links to effectively descend to the lower limit. In the FIG. 3, reference numeral W and P indicate wood and putter respectively, which has not been described up to now.

As described above, in accordance with present invention, the golf bag includes a plurality of cross partition walls and a longitudinal partition wall crossing said the cross partition walls in the top frame 1, the base frame 2 and the main frame 3 such that the cross partition walls and the longitudinal partition wall forms together separate rooms of a lattice type having a plurality of iron receivers 10 and 10′ in the middle thereof, at least one wood receiver 11 and at least one putter receiver 12 in the both side of the iron receivers in the front-to-back direction of the golf bag. And heads of the irons are inserted into the base frame located on the lower portion of the golf bag body and grips of the iron are exposed from the upper portion of the golf bag in the manner of upside-down of the irons made of heavy metal so that the center of gravity in the golf bag becomes more lower and the club heads can be prevented from being collided or rubbed with each other. Therefore, when the golf bag stands up without moving, it is hardly occurred for the golf bag to fall down because of the stability of the golf bag with the lower center of gravity. And even when carrying it with the carrying handle 6, the tilting phenomenon of the golf bag caused by the club hardly occurs due to the lower center of gravity in the golf bag of present invention, compared with prior art.

The iron receivers 10 and 10′ continuosly and vertically extended from the top frame 1 to the base frame 2 via the main frame 3 have various sizes of widths according to lofts of the iron heads. Therefore, the individual irons can be effectively and properly received in the forms of upside-down in the corresponding receivers which are adapted to shapes and sizes of iron heads thereof respectively. And since the iron heads are fitted tightly to the base frame 2, the received irons can be almost fixed and not be movable in the frames and the golf bag can be moved easily without the interference due to movements of the irons. And the iron receivers 10 and 10′ have the numbers of their own on their walls for identifying the kinds of the received irons when playing the golf game or if necessary. And besides them, identification sticker or some numbers may be attached to or printed on end portions of the iron grips which would be exposed upwardly from the golf bag body 100 so that the wanted iron I can be easily and in place received in or taken out of the golf bag, if necessary.

According to such a structure in the golf bag of present invention, the collisions or frictions between the heads of the irons do not occur in the golf bag.

Meanwhile, since the woods received in one wood receiver are only two or three in number thereof, and are all different from one another in lengths thereof, the collisions or friction not only between the wood heads but also between all the clubs received in the golf bag body 100 hardly occur in the golf bag of present invention so that the damages of the clubs or the noises caused by the collisions of the club heads can be prevented to prolong the life of the clubs and improve the feeling of handling the golf bag.

And it is preferable that the top frame 1 and the base frame 2 are covered with cushion materials or textures. This can prevent the club heads which frequently are taken in or out of the golf bag from being damaged, and can facilitate the clubs to smoothly come in and out in the golf bag.

And in accordance with present invention, the golf bag has a pair of wheels 24 on both corners of the base frame 2 adjacent to which front side and bottom side of the base frame continue with each other. The intervals between the two wheels 24 can be extended exteriorly from or retracted interiorly into the base frame in the horizontal direction or side-to-side direction of the golf bag according to the up or down of the lift pipe 23. When the interval of the wheels 24 increases, that is, when wheels 24 come out from the both corners to the base frame 2, interval between supporting points of the golf bag load increases by the increased interval between the two wheels such that the golf bag do not easily tilt to one side or fall down, and can be effectively moved with more little effort, when moving for example under rounding.

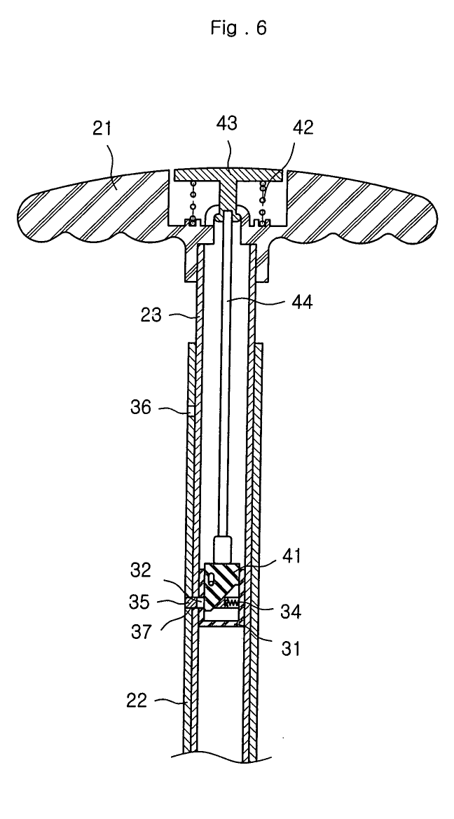

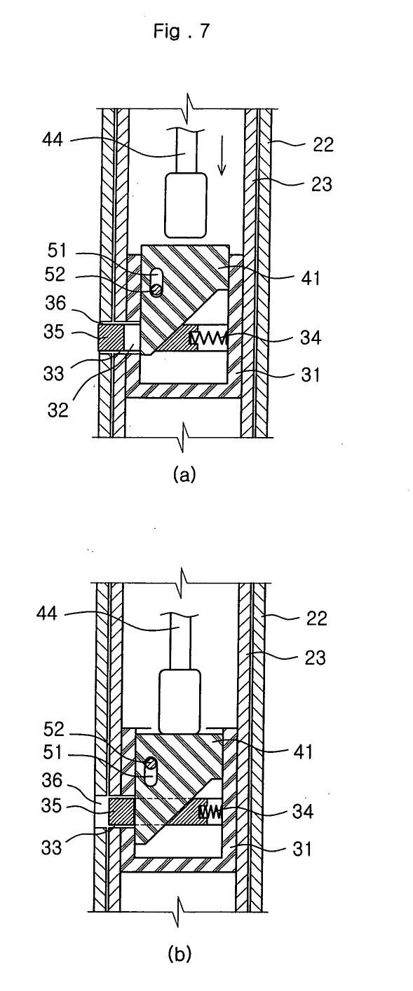

Hereinafter, operation of a wheel unit 20 including the wheels 24 will be described in more detail. Referring to the FIG. 8a, in the case that the wheels do not get out of the corners of the base frame, a pair of links 63 stand up together to upper limit thereof so that the links 63 form together a reversed “V”. At the same time, end portion of the engaging bar 35 is inserted into the higher engaging hole 36 formed on relatively higher portion of the guide pipe 22 to lock both the guide pipe 22 and the lift pipe 23 together as shown in FIGS. 6 and 7a. And the lower engaging hole 37 is formed on relatively lower portion of the guide pipe 22 as shown on FIG. 6.

When the engaging bar 35 is inserted into the higher engaging holes 36 in the end portion thereof such that the lift pipe 23 can not be moved vertically along the guide pipe 22, and when an user presses downwardly the pressing button 43 disposed on the middle portion of a lift handle 21 attached to the top end of the lift pipe 23, the pressing rod 44 attached to the pressing button 43 in the top end, descends and transmits the pressing force of the pressing button 43 to the top end of the slope piece 41 within the lift pipe 23 as shown in FIG. 6 and 7b. Then the slope piece 41 comes down and penetrates through the through hole 32 of the engaging bar 35 so that the incline plane of the slope piece 41 slides over the corresponding incline plane of the through hole 32 to urge the engaging bar 35 against the elastic force of the spring 34 in the direction opposite to the higher engaging hole 36, if the urge force of the slope piece 41 exceeds the predetermined elastic force of the spring 34 which has one end portion attached to the corresponding end of the engaging bar 35.

As shown in FIG. 7b, if the slope piece 41 come down to the lower limit and the stopper 52 reaches the uppermost end of the prolonged slot 51 formed on the slope piece 41, the slope piece 41 can not come down any more in the through hole 32 of the engaging bar 35. At the same time, the engaging bar 35 retracts further backwardly against the elastic force of the spring 34 and the end portion of the engaging bar 35 escapes from one of the engaging holes 36 and 37 such that the lift pipe 23 is unlocked from the guide pipe 22 and can be freely moved up or down along the guide pipe 22.

In this state mentioned above, the user can descend the lift pipe 23 such that the pass hole 33 penetrating one-side walls of both the casing 31 and the lift pipe 23 also descends and does not align to the higher engaging hole 36 with each other. And then if the user draws back from the pressing button 43, the pressing button 43 is moved upwardly by the force of button spring 42 such that the pressing rod 44 lifts up and does not press the slope piece 41 on the top end thereof. Consequently, the engaging bar 35 is urged to the original site, that is, to the higher engaging hole 36 by the elastic force of the spring 34, pressing the slope piece 41 upwardly with the incline planes of both the slope piece 41 and the through hole 32 contacted in sliding manner. However, the engaging bar 35 cannot go further to be inserted into the higher engaging hole 36 because the path hole 33 and the higher engaging hole 36 do not align with each other.

In this state, as the lift pipe 23 descends gradually, the downward force of the lift pipe 23 causes a pair of links 63 linked with a junction means formed on the lower portion of the lift pipe 23 to get wider in the lower ends thereof. So, the wheel shafts 25 linked with the corresponding links 63 get pushed in the left and right directions to push out the wheels 24 which are also linked with the corresponding ends of the shaft 25. As a result, the wheels 24 come out from the corners of the base frame 2 as much as the descending amount of the lift pipe 23.

From this state, as the lift pipe 23 further comes down, the path hole 33 formed on and passing through the same-side walls of the casing 31 and the lift pipe 23 will eventually align with the lower engaging hole 37 formed on relatively lower portion of the guide pipe 22 as shown in FIG. 6. At the same time, the end portion of the engaging bar 35 is forced and fitted to the engaging hole 37 by the spring 34 coupled with other end of the engaging bar 35. Therefore the lift pipe 23 is locked with guide pipe 22 such that the lift pipe 23 cannot move up or down along the guide pipe 22. In the locking state of the lift pipe 23, the pair of links 63 extend completely and lineally in horizontal direction such that the wheels 24 come out extremely or at most from the corners of the base frame 2 to the left and right side. As a result, the user can pull the golf bag more safely with the largest interval between the two wheels.

According to the above operation steps and with the largest interval between the two wheels, the user can easily move the golf bag inclined to some degree by pulling it on the ground with the pulling handle 5 or carrying handle 6 as shown in FIGS. 9 and 10.

And for example, when the golf bag stays in small space for a long time or when user carries the golf bag on his shoulder by shoulder strips(not shown), the come-out wheels would require more space for storing or interfere to carry the golf bag for example by touching other possible-articles to give inconvenience to user. Therefore it is preferable that the wheels 24 restore to the front-and-lower corners of the base frame 2 when storing or carrying the golf bag.

In connection with the restoring of the wheel, after user release the engaging bar 35 from the lower engaging hole 37 and ascends the lift pipe 23 up to the higher limit where the path hole 33 aligns with the higher engaging hole 36, the engaging bar is inserted into the higher engaging hole 36 to make the lift pipe 23 locked with the guide pipe 22 and at the same time to restore the snap spring 62 disposed on the lower portion of the lift pipe 23 to the shrink state from the unfolding status. And the ascending process of the lift pipe 23 is easier than the descending process of it due to the restoring force of the snap spring 62. Besides, because other than operations for ascending the lift pipe are very similar to those for descending the lift pipe, they will be omitted hereafter.

In accordance with the structure of present invention mentioned above, various kinds of golf clubs can be received separately or classifiably in the corresponding receivers of the golf bag such that the irons get upside-down with the iron heads received in the base frame so as to prevent the club heads from being collided with each other or generating the noise due to the collision between the clubs in the golf bag and prolong the life of the clubs. Also, since the center of gravity in the golf bag is relatively in lower portion thereof with all or some of the club heads received in the base frame, the golf bag get increased in stability thereof to hardly tilt to on side or fall down and to hardly be moved not only when it stays in its standing-up posture but also when it is carried for example under rounding.

And since the pair of the wheels can be easily taken in or out of the corners of the base frame such that the intervals between the two wheels can be easily extended or retracted, the golf bag can be easily pulled on the ground with the improved stability or good landing status so that the golf bag did not easily tilt to one side or fall down. Therefore it is very easy even with more little effort or labor to handle the golf bag of present invention.

It will also be recognized that modifications to the above would be obvious to anyone of ordinary skill in the art without departing from the scope of the claims appended herein below.

1-4. (canceled)

5. A golf bag for receiving and carrying a plurality of golf clubs therein, said golf bag comprising:
a main frame having a front face along with front and lower side corers, said front face having a middle portion;
said golf bag including a guide pipe fixedly mounted on the middle portion of the front face of the main frame and extending in the vertical direction when the golf bag is in an upright position;
a lift pipe fitting into the guide pipe and sliding along the guide pipe in the vertical direction, said lift pipe having a lift handle on the top end thereof and a junction means on the lower end thereof, and the top end of the lift pipe protruding upwardly and exteriorly from an upper portion of the golf bag body;
a locking means disposed within the guide pipe for locking the movement of the lift pipe;
an unlocking means disposed within the guide pipe for unlocking the locking means;
a pair of wheels having wheel shafts, said wheels being rotationally mounted on the front and lower side corners of the main frame, each of the wheels connecting with the wheel shafts on one end of the respective wheel shaft;
a connecting means pivotally mounted between the junction means of the lift pipe and the wheel shafts such that the vertical movement of the lift pipe moves the connecting means and the wheels for increasing or decreasing the horizontal distance between the wheels.

6. The golf bag as claimed in the claim 5, wherein the locking means includes:
a casing fixedly fitted on an inner portion of the lift pipe and disposed at a predetermined height along the lift pipe, the casing having an opening on an upper end and a closure on a lower end;
an engaging bar disposed within the casing, the engaging bar having a through hole having a downward incline plane on an interior side wall thereof to downwardly and gradually reduce an opening size of the through hole,
higher and lower engaging holes passing through horizontally lower and higher portions of one side wall of the guide pipe;
a path hole passing through adjacent side walls of both the lift pipe and the casing which are adjacent to said one side wall of the guide pipe; and
a spring attached between an end of the engaging bar and another side wall of the casing for urging the engaging bar to said one side wall of the casing such that the engaging bar is inserted into and engages one of the higher and lower engaging holes.

7. The golf bag as claimed in the claim 6, wherein the unlocking means includes:
a slope piece movably fitted on the casing in the vertical direction, the slope piece having an incline plane matching with the incline plane of the through hole,
the slope piece being inserted into the through hole and the inclined plane of the sloped piece contacting the inclined plane of the engaging bar for urging the engaging bar against the force of the spring for unlocking the guide pipe from the lift pipe;
a secession-prevention means for keeping said slope piece within the casing;
a lift handle fixedly mounted on the top end of the lift pipe, the lift handle having a pressing button on the middle thereof, and button springs for urging upwardly the pressing button;
a pressing rod connected between a lower end of the press button and a top end of the slope piece for transmitting the pressing force of the press button to the slope piece.

8. The golf bag as claimed in the claim 7, wherein:
the secession-prevention means includes a prolonged slot vertically extending on the slope piece, and a stopper formed on the casing;
a protruded end of the stopper being idly inserted into the prolonged slot such that the slope piece moves in the casing between an upper limit for removing the engaging bar from one of the higher and lower engaging holes and a lower limit for inserting the engaging bar into one of the higher and lower engaging holes.

9. The golf bag as claimed in the claim 5, wherein the connecting means includes:
a pair of links each having one end pivotally and commonly connected with said junction means of the lift pipe by a pin, and another end of each link separately and pivotally connecting with the other end of each shaft by pins respectively; and
a snap spring having a middle portion which pivotally connects with the junction means of the lift pipe, and both ends of the snap ring pivotally and separately connecting with a middle portion of each link respectively.
